(19) United States
(12) Patent Application Publication
(10) Pub. No.: US 2008/0038963 A1
(43) Pub. Date: Feb. 14, 2008

(54) Receptacle connector and apparatus having the same

(76) Inventor: Kenichi Hirokawa, Tokyo (JP)

Correspondence Address: TAKEUCHI & KUBOTERA, LLP, Suite 202, 200 DAINGERFIELD ROAD, ALEXANDRIA, VA, 22314, US

(21) Appl. No.: 11/790,695

(22) Filed: Apr. 26, 2007

(30) Foreign Application Priority Data
Apr. 28, 2006 (JP) 2006-126373

(51) Int. Cl. H01R 24/00

(52) U.S. Cl. 439/676

(57) ABSTRACT

There are provided a housing having a fitting section to fit a mating connector therein; a terminal that can contact with the mating connector fitted in the fitting section; a shielding plate that covers an outer portion of the housing; and a grounding spring that is provided in the fitting section of the housing and is electrically isolated from the shielding plate. The grounding spring has a contact section to contact with the mating connector fitted in the fitting section, and a grounding section to connect to the ground. The shielding plate has a grounding section to connect to ground. There may be further provided a current shielding member between the grounding section of the grounding spring of the receptacle connector and the ground.

### BACKGROUND TECHNOLOGY AND RELATED TECHNOLOGY

The present invention relates to a receptacle connector, more specifically, a receptacle connector having a grounding function, and an apparatus having the receptacle connector.

Receptacle connectors with various shapes have been used for connecting between computers or LAN (local area network). The receptacle connectors are attached to communicating devices at specific positions thereof, for example, a casing panel of a computer, so that the receptacle connectors can be connected to each other by a shielded cable or the like.

An example of the receptacle connector may include a modular jack. The modular jack is a component of a modular connector, and generally used as a pair with a modular plug. Using a shielded cable having two modular plugs at both ends thereof, two modular jacks can be connected to each other.

There may be a case that an electric current flows or a voltage applies to the modular jacks from computer devices having the modular jacks. Therefore, an undesired current may flow sometimes between the modular jacks. For this reason, it is preferable that the modular jacks have a grounding function.

FIG. 7 is a view showing a conventional receptacle connector having a grounding function, which is disclosed in Patent Reference. A modular jack 91 mainly comprises an insulating housing 92, terminals 93 arranged in the housing 92, and a shielding plate 96 that covers an outer portion of the housing 92. A necessary number (two in the figure) of dented portions 97 and 98 are formed in the housing 92 from a front face thereof. A modular plug for LAN (not illustrated) fits to the dented portion 97, and a modular plug for a modem fits to the dented portion 98.

A grounding piece 108 is formed as a part of the shielding plate 96 by bending like a cantilever from a front face 106 of the dented portion 97 to a back face thereof. A distal end of the grounding piece 108 slightly protrudes toward an inside of the dented portion 97. Furthermore, portions 110 of side faces 109 of the shielding plate 96 extend downward, so as to be able to connect to ground by connecting to a grounding board or the like. Through the connection to ground, the grounding piece 108 is connected to ground.

When the modular plug attached to a shielded cable and having an outer portion covered with a shielding plate fits to the dented section 97, the shielding plate of the modular plug contacts with the grounding piece 108, which is a part of the shielding member 96 of the modular jack 91. Therefore, the shielding plate that covers the outer portion of the modular plug contacts with the shielding plate 96 of the modular jack 91. As a result, through the portions 110 of the shielding plate 96 of the modular jack 91, which are connected to ground, the modular plug and the modular jack 91 integrally connect to ground.

In the conventional receptacle connector having such a grounding function, an undesired result may occur depending on an installation state of the devices having the receptacle connectors. For example, when the shielding plate that covers the outer portion of the modular plug and the shielding plate 96 of the modular jack 91 are connected, ground levels between the devices, to which the modular jack 91 is attached, are shared through the shielded cable, the modular plug covered by the shielding plate, and so on. For this reason, when a potential difference is generated between the devices, there is a concern of transmission failure.

In addition, when a ground level of a device having one receptacle connector is 100 V, and a ground level of a device having another receptacle connector is 0 V, a direct current flows via the shielded cable and the modular plug from the receptacle connector of the device at the 100 V ground level to the receptacle connector of the device at the 0 V ground level due to the electrical potential difference between the devices. The direct current may generate noise in the devices, and cause communication failure between the devices.
[Patent Reference] Japanese Patent Publication No. 2002-352918

The electrical potential difference that can be generated between the devices cannot be a problem, for example, when the shielded cable is not used, or when a non-shielded modular plug, i.e. a modular plug without a shielding, is used. However, as the networking technology advances, a cable to connect between receptacle connectors is required to flow high-speed signals, such as 10 Gbps, and since especially such high-speed signals tend to be influenced by noise, a connecting method, in which a shielded cable is not used, or a connecting method without using a modular plug that does not have a shield, is not preferred.

The present invention is provided to solve the above problems in the conventional technique, and noise generation can be effectively prevented even when a shielded cable or a modular plug having shield is used. Furthermore, the present invention provides a receptacle connector and an apparatus having such a receptacle connector that can block an undesired current between the receptacle connectors.

### SUMMARY OF THE INVENTION

The present invention relates to a receptacle connector, comprising: a housing having a fitting section to be fitted to a mating connector; a terminal that can contact with the mating connector fitted to the fitting section; and a shielding plate that covers an outer portion of the housing. The receptacle connector has a grounding spring, which is electrically isolated from the shielding plate, in the fitting section. The grounding spring has a contact section that contacts with the mating connector fitted to the fitting section and a first grounding section to connect to ground. The shielding plate has a second grounding section to connect to the ground.

In the receptacle connector, the first grounding section of the grounding spring may connect to the ground through a board connected to the ground.

In the receptacle connector, the grounding spring may have a spring contact section, which is the contact section that contacts with the mating connector fitted to the fitting section, a locking section that is used as a locking member to the housing when the grounding spring is attached to the housing, a press-in securing section to press in and secure in the housing, and a board-connecting section to connect the grounding spring to the ground.

In the above-described receptacle connector, the second grounding section of the shielding plate may be attached to a panel connected to the ground, so that the second grounding section connects to the ground.

In addition, in the above-described receptacle connector, the receptacle connector may be a modular jack, and the mating connector may be a modular plug.

Furthermore, in the receptacle connector, the receptacle connector may be a modular jack, and the mating connector may be a modular plug. The spring contact section of the grounding spring may contact with the shielding plate that covers the outer portion of the modular plug.

In addition, according to the invention, in any of the receptacle connectors described above, there is provided an apparatus having a current shielding member disposed between the first grounding section of the grounding spring and the ground. Here, the current shielding member may be a capacitor.

Furthermore, in the above-described apparatus, the capacitor may be mounted on a board.

According to the invention, an undesired current flow due to ground levels of devices can be prevented between the devices which are connected to the receptacle connectors.

### BRIEF DESCRIPTION OF THE DRAWINGS

FIG. 1 is a perspective view of a modular jack according to an embodiment of the invention;

FIG. 2 is a vertical sectional view taken along a line 2-2 in FIG. 1;

FIG. 3 is a horizontal sectional view taken along a line 3-3 in FIG. 2;

FIG. 4 is a sectional view taken along a line 4-4 in FIG. 1, only showing a housing and a grounding spring;

FIG. 5 is a perspective view of the grounding spring;

FIG. 6 shows an example of a modular jack, which is a receptacle connector, in use according to the invention; and

FIG. 7 shows a conventional receptacle connector having a grounding function.

### DETAILED DESCRIPTION OF THE EMBODIMENTS

Hereunder, referring to accompanying drawings, preferred embodiments of the invention will be described.

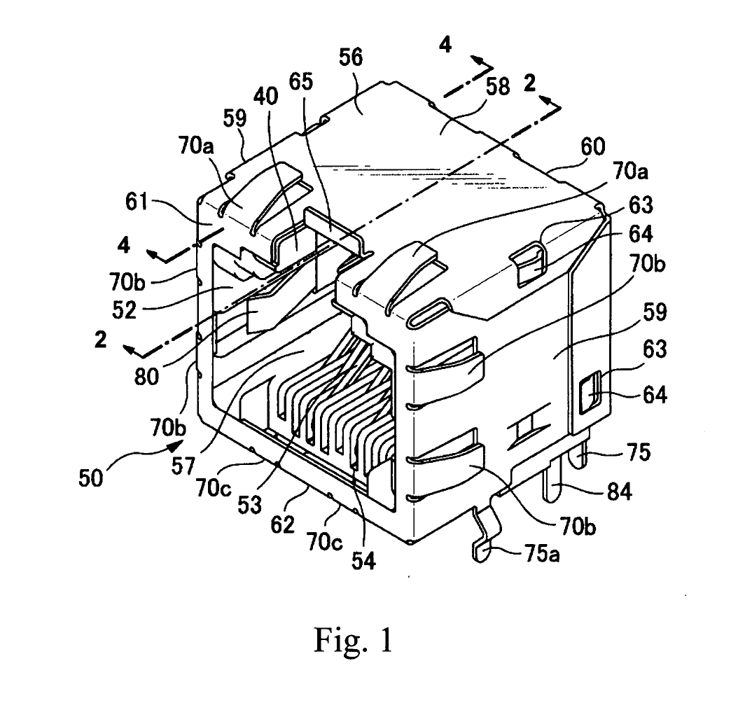

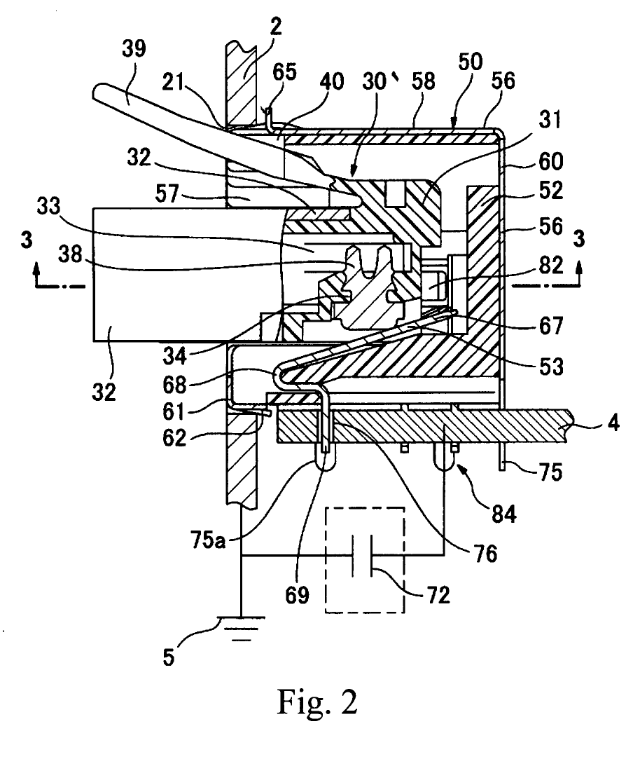

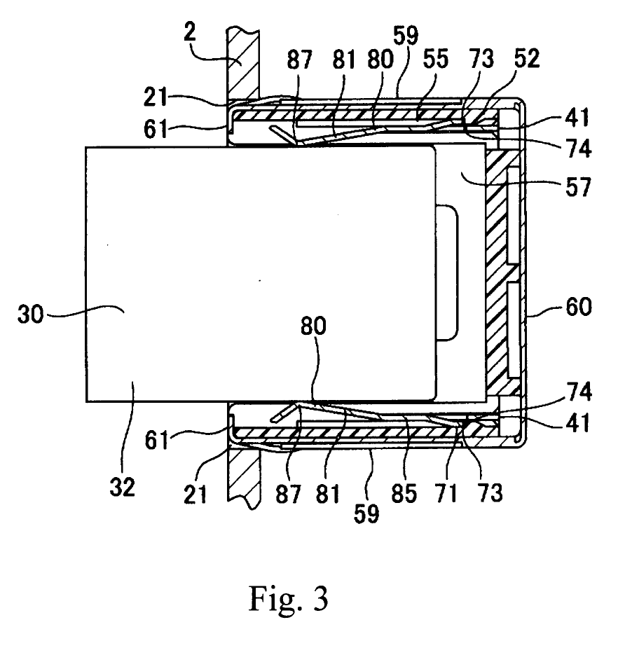

FIG. 1 is a perspective view of a modular jack 50, which is an example of a receptacle connector, according to the invention. FIG. 2 is a vertical sectional view taken along a line 2-2 in FIG. 1. In FIG. 2, a modular plug 30 fits into a modular jack 50 that is mounted to a panel 2. FIG. 3 is a horizontal sectional view taken along a line 3-3 in FIG. 2.

FIGS. 2 and 3 show an example of the modular plug 30 that can be fitted to the modular jack 50. The modular plug 30 is a member to connect a plurality of wires, such as cables, together with a shielded wire (not illustrated). While attached to an edge of a shielded cable 3, the modular plug 30 fits to the modular jack 50 to connect between the modular jack 50 and a mating receptacle connector (e.g. modular jack) via the shielded cable 3.

The modular plug 30 mainly comprises a rectangular insulating housing 31 made of a resin or the like, a shielding plate 32 to cover an outer portion of the housing 31, and terminals 38 attached to respective wires 33 of the shielded cable 3 through slits 34 provided in the housing 31. On an upper part of the rectangular housing 31, an elastic tongue 39 is provided to lock the modular plug 30 to the modular jack 50 by engaging with a corresponding dented section 40 of the modular jack 50. Here, a shielded wire (not illustrated) disposed in the shielded cable 3 is electrically connected to the shielding plate 32.

The modular jack 50 illustrated in FIGS. 1 to 3 mainly comprises a rectangular insulating housing 52 made of a resin or other materials, terminals 53 that are made of a metallic material and arranged in a fitting section 57 of the housing 52, grounding springs 80, which are similarly arranged in the fitting section 57 of the housing 52 and made of a metal material, and a shielding plate 56 that covers the outer portion of the housing 52. Here, the terminals 53, the grounding springs 80, and the shielding plate 56 are physically and electrically independent separate members, respectively, and are attached to the housing 52 independently from each other.

A dented section 57, which is the fitting section, is formed from a front face of the housing 52 to a back face thereof. The modular plug 30 (see FIGS. 2 and 3) can fit in the dented section 57. Corresponding to the terminals 38 of the modular plug 30, a necessary number, for example, eight, of the terminals 53 are arranged in parallel along arranging grooves 54 of the housing 52.

Each of the terminals 53 has an elastic section 67, a vertical lower end 69, and a bent section 68 that connects the elastic section 67 and the vertical long end 69. The elastic section 67 can elastically contact with the terminal 38 of the modular plug 30 by an effect of the bent section 68 when the modular plug 30 fits in the dented section 57. In addition, when each of the terminals 53 is secured at a specified position of the arranging groove 54, the vertical lower end 69 protrudes downward through a bottom face of the housing 52 and a hole 76 of a board 4, and can electrically connect with a specific circuit (not illustrated) on the board 4.

The shielding plate 56 is made of one sheet metal through bending and punching. The shielding plate 56 substantially covers an upper face, side faces, the back face, a part of the bottom face, the front face except an inlet of the dented section 57 (fitting section), and a part of the bottom face of the housing 52 by an upper face 58, left and right side faces 59, a back face 60, a front face 61 and a bottom face 62 thereof, respectively. It is not necessary to cover all the faces of the housing.

In order to surely secure the shielding plate 56 to the housing 52, engaging holes 63 are provided in extending sections, which are made by bending the upper face 58 and then the back face 60 of the shielding plate 56 to the left and right faces 59. Correspondingly, engaging protrusions 64 are provided at corresponding positions on the left and right faces 59 of the shielding plate 56. In addition, a board connecting section 75, which extends below the back face 60, is formed to connect the shielding plate 56 to ground 5. The board connecting section 75 can work as a grounding section to connect the shielding plate 56 to the ground 5 by connecting with the board 4 connected to the ground 5.

In order to secure the shielding plate 56 to a board or the like, board temporary securing sections 75a that extend under the left and right side faces may be provided as illustrated in the figure. Similarly to the board connecting section 75, the board temporary securing sections 75a also can work as grounding sections to connect the shielding plate 56 to the ground by connecting to the board 4 that is connected to the ground 5. Here, even when the modular plug 30 fits to the modular jack 50, the shielding plate 56 does not directly or even indirectly contact with the modular plug 30. Furthermore, there is no electrical connection between the shielding plate 56 and the modular plug 30.

In order to connect the shielding plate 56 to the ground 5 via the panel 2 to shield noises, grounding pieces 70 that can be used as grounding sections of the shielding plate 56 are formed extending from the front face of the shielding plate 56 to the back face thereof, while being bent like a cantilever. Total eight grounding pieces 70a, b, and c are provided so as to provide two pieces each on each side around the opening of the dented section 57. End portions of the grounding pieces 70 are slightly bent toward a main body of the housing 52. The modular jack 50 is inserted from a backside of the panel 2 into a panel hole 21 of a casing panel of a computer or the like, and elastically held there by the contact of the end portions of grounding pieces 70, which are slightly bent, with edges of the panel 2. At the same time, the shielding plate 56 physically and electrically contacts with the panel 2 through the contact between the grounding pieces 70 and the panel 2.

The panel 2 connects to the ground 5, and thereby the shielding plate 56 indirectly connects to the ground 5 through the contact with the panel 2 that connects to ground, so that the panel 2 is used as a grounding section of the shielding plate 56. Here, in order to prevent the modular jack 50 attached in the hole 21 of the panel 2 from coming off from the panel 2, a part 65 of the upper face 58 of the shielding plate 56 can be vertically bent upward so as to touch the edge of the panel 2, as shown in the figure. Here, in the embodiment of the invention, the grounding pieces 70 are integrally formed with the shielding plate 56 through bending, and a grounding piece (not illustrated) may extend from the panel 2 and physically and electrically contact with the shielding plate 56.

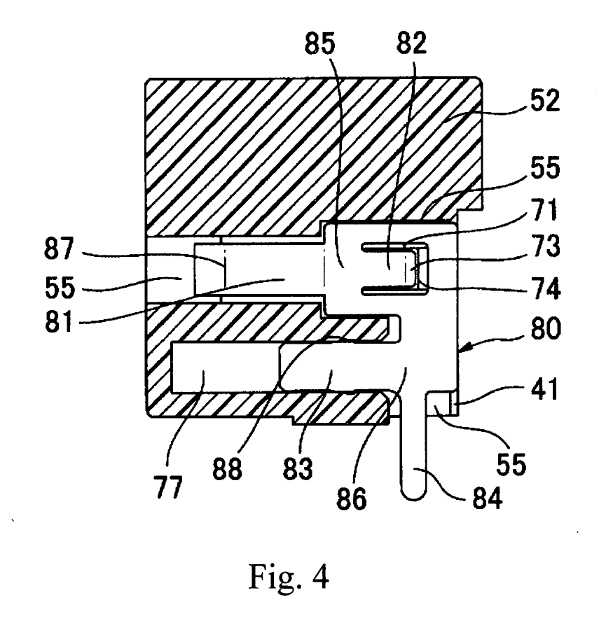

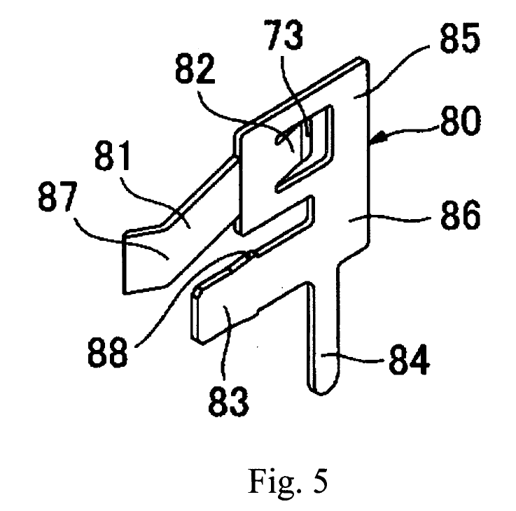

From now on, referring also to FIGS. 4 and 5, a configuration of a grounding spring 80 will be described in detail. FIG. 4 is a sectional view taken along a line 4-4 in FIG. 1, and shows only the housing 52 and the grounding spring 80. FIG. 5 is a perspective view of the grounding spring 80.

The grounding springs 80 are inserted frontward from slit grooves 41 provided in a backside of the housing 52 along left and right inner walls of the dented section 57 of the housing 52. Each of the grounding springs 80 mainly comprises a wide section 85, a spring contact section 81, which is formed like a cantilever by bending so as to extend from the wide section 85 in an inserting direction, a lance section 82 provided like a cantilever so as to extend in a direction opposite to the inserting direction by cutting and lifting near a center of the wide section 85 into a U-shape, a lower extending section 86 that extends downward under the wide section 85, a press-in securing section 83 that extends from the lower extending section 86 along the inserting direction in parallel to the spring contact section 81, and a board connecting section 84 that is narrow and extends downward from the lower extending section 86. Here, while the spring contact section 81 is elastically bent toward the dented section 57 of the housing 52, the lance section 82 is elastically bent in a direction opposite to the dented section 57 of the housing 52.

When the modular plug 30 fits in the dented section 57 of the modular jack 50, the spring contact sections 81 can elastically contact with side faces of the shielding plate 32 that cover the outer portion of the modular plug 30. In order to make the contact easy, a contact point section 87, which is bent backward in a direction opposite to a bending direction of the spring contact section 81, is formed around a distal end of each of the spring contact sections 81. The lance sections 82 are members used as a locking member to the modular jack 50 when the grounding springs 80 are attached to the modular jack 50, and have bent sections 73 near end portions thereof, which are formed by bending toward the inner wall of the housing 52. Furthermore, the press-in securing sections 83 are used as parts pressed in and secured to the housing 52 of the modular jack 50.

When the grounding springs 80 are secured onto the housing 52, the grounding springs 80 are pressed into press-in sections 77 of the housing 52 by a certain force by press-in protrusions 88 provided near centers of the press-in securing sections 83. In addition, at this time, the wide sections 85, the spring contact sections 81, and the lower extending sections 86 can be arranged along dents 55 of the housing 52, which are formed so as to fit to those shapes. In addition, the lance sections 82 are caught and locked to bent sections 73 at step sections 74 formed at deep dents 71, which are deeper than the dents 55, thereby facilitating positioning of the grounding springs 80.

The board connecting sections 84 are parts to connect to the board that is connected to the ground 5. Upon connecting to the board 4, the board connecting sections 84 directly connect to the board 4, and then indirectly connect to the ground 5, for example, via a capacitor 72, which is a current shielding member mounted on the board 4 at an appropriate position. When the modular jack 50 is connected to the capacitor 72 in this way, the whole structure can be considered not just as the modular jack 50 but one device, in which the capacitor 72 or the like is added to the modular jack 50 as the current shielding member.

By connecting the board connecting sections 84 to the ground 5 via the board 4, the modular plug 30 fits to the modular jack 50. Accordingly, when the grounding springs 80 electrically connect at the spring contact sections 81 thereof to the shielding plate 32 of the modular plug 30 or the shielded cable 3, and further connect with the mating receptacle connector and a device to which the mating receptacle connector is attached, the grounding springs 80 connect to the ground 5 through the board connecting sections 84. Therefore, noise generation can be effectively prevented. In this case, the board connecting sections 84 can work as grounding sections of the grounding springs 80.

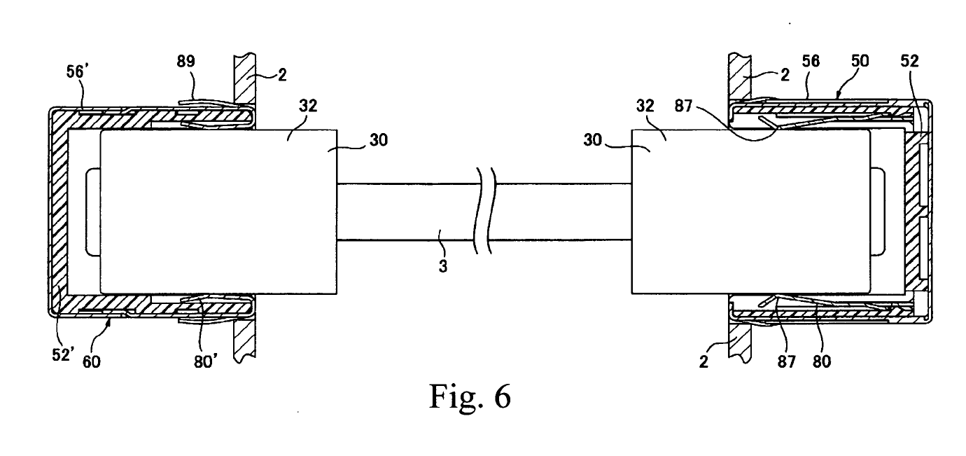

The capacitor 72 is disposed between the board connecting sections 84 and the ground 5. Accordingly, even if an electrical potential difference occurs between a ground level of the modular jack 50 and a ground level of the shielding plate 32 or the shielded cable of the modular plug 30, and even a ground level of the device to which the mating receptacle connector is attached, an electric current will not flow through the shielded cable 3 or the modular plug 30 by the electrical potential difference. More specifically, a direct current component that could flow therebetween can be effectively blocked. This effect will be described below in more detail, referring to FIG. 6.

FIG. 6 an example of the modular jack 50 in use according to the invention, and is a horizontal sectional view similar to FIG. 3. The modular plug 50 electrically connects to a modular jack 60, which is the mating receptacle connector, using the modular plugs 30 attached to the both ends of the shielded cable 3.

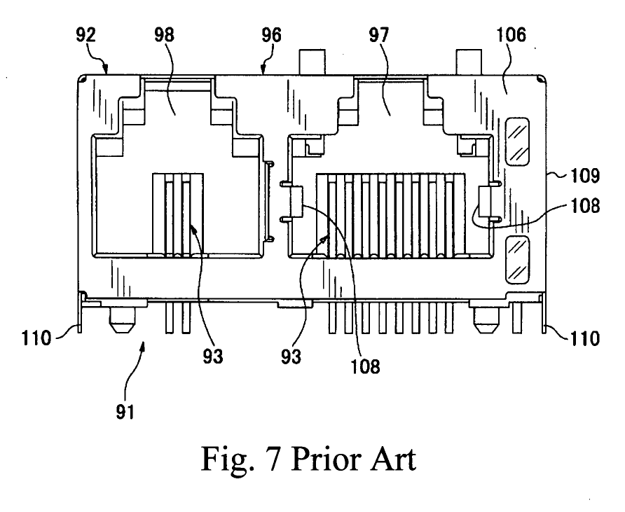

Here, the modular jack 60 is a modular jack, which has grounding springs 80′ that are members of the shielding member 56, similar to a conventional example illustrated in FIG. 7. Here, in the modular jack 60, members that correspond to the members of the modular jack 50 are indicated with Especially, it should be noted that a shielding plate 56′ of the modular jack 60 electrically connects to the shielding plate 32 of the modular plug 30 through the grounding springs 80′, and connects to the panel 2 through the spring pieces 89.

In the connecting situation, if the ground level at the modular jack side 60 is 100 V, and the ground level at the modular jack side 50 is 0 V, and if there is no current shielding member such as the capacitor 72, a current might flow from the modular jack 60 to the modular jack 50 by the potential difference, thereby causing undesired noise.

On the other hand, according to the configuration described above, since the capacitor 72 is provided between the grounding springs 80 and the ground 5, which are electrically isolated from the shielded cable 3 and the modular plug 30, and since the capacitor 72 works to block a direct current component, a current does not flow between them, for example, the shielded cable 3 and the shielding plate 32 of the modular plug. Therefore, according to the configuration, undesired noise generation can be effectively prevented.

According to the embodiment of the invention described above, the grounding springs 80 are made of a metallic material, and may be made of a resin plated with a metal. In addition, as easily understood, the grounding spring may be formed of two components and a capacitor is provided between the two components. Furthermore, the present invention is described using the modular connector as an example, and the present invention can be widely applied to a connector having a function of a receptacle connector. The present invention is not limited to the modular connector, and is applicable to various types of connectors. Therefore, the present invention is not limited to the modular connector.

The present invention can be applied to various apparatus which require receptacle connectors.

1. A receptacle connector to be connected to a mating connector, comprising:
a housing having a fitting section for fitting the mating connector therein;
a terminal disposed in the fitting section for contacting with the mating connector;
a shielding plate for covering the housing, said shielding plate having a first grounding section for connecting to ground; and
a grounding spring disposed in the fitting section of the housing and electrically isolated from the shielding plate, said grounding spring having a contact section for contacting with the mating connector and a second contact section for connecting to the ground.

2. The receptacle connector according to claim 1, wherein said second grounding section is adopted to connect to the ground through a board connected to the ground.

3. The receptacle connector according to claim 1, wherein said contact section is formed of a spring contact section.

4. The receptacle connector, according to claim 1, wherein said grounding spring includes a locking section for engaging the housing; a press-in securing section pressed in and secured to the housing; and a board connecting section for connecting the grounding spring to the ground.

5. The receptacle connector according to claim 1, wherein said first grounding section is attached to a panel connected to the ground so that the first grounding section connects to the ground.

6. The receptacle connector according to claim 1, wherein said receptacle connector includes a modular jack, said mating connector including a modular plug.

7. The receptacle connector according to claim 3, wherein said spring contact section is adopted to contact with a mating connector shielding plate of the mating connector.

8. An apparatus comprising the receptacle connector according to claim 1; and a current shielding member disposed between the grounding section of the grounding spring and the ground.

9. The apparatus according to claim 8, wherein said current shielding member includes a capacitor.

10. The apparatus according to claim 9, wherein said capacitor is mounted on a board.
